(19) United States
(12) Patent Application Publication
(10) Pub. No.: US 2019/0372948 A1
(43) Pub. Date: Dec. 5, 2019

(54) SCALABLE FLOW BASED IPSEC PROCESSING

(71) Applicant: Nokia Solutions and Networks Oy, Espoo (FI)

(72) Inventors: Abi VARGHESE, Bangalore (IN); Amal Pillai, Bangalore (IN); Yusuf Khan, Neu-Ulm (DE)

(21) Appl. No.: 15/995,973

(22) Filed: Jun. 1, 2018

(51) Int. Cl. H04L 29/06; H04L 12/851; H04L 12/46

(52) U.S. Cl. CPC H04L 63/0485; H04L 47/2483; H04L 63/164; H04L 12/4633; H04L 69/22

(57) ABSTRACT

A method of identifying a flow in a received data stream from a secure tunnel, including receiving a plurality of data packets including a flow identification and an encrypted data portion, separating a flow identification from the encrypted data portion, distributing the plurality of data packets to a plurality of processing cores, wherein all the packets associated with a flow identification are distributed to the a processing core.

### TECHNICAL FIELD

Embodiments are related to transferring data in an Internet protocol security (IPSec) setting. More particularly, embodiments described herein relate to flow identification and scalability in IPSec processing.

### SUMMARY

Some simplifications and omissions may be made in the following summary, which is intended to highlight and introduce some aspects of the various exemplary embodiments, but not to limit the scope of the invention. Detailed descriptions of a preferred exemplary embodiment adequate to allow those of ordinary skill in the art to make and use the inventive concepts will follow in later sections.

Embodiments include a method of identifying a flow in a received data stream from a secure tunnel, including receiving a plurality of data packets including a flow identification and an encrypted data portion, separating a flow identification from the encrypted data portion, distributing the plurality of data packets to a plurality of processing cores, wherein all the packets associated with a flow identification are distributed to a same processing core.

The method may include decrypting data packets in multiple flows based on the flow identification information by the plurality of processing cores, wherein the decryption of the multiple flows occurs in parallel.

Distributing the plurality of data packets may be performed by header inspection without decryption of the packet.

Distributing the plurality of data packets may be performed using a hashing function.

Distributing the plurality of data packets may be performed using receiver side scaling.

A packet order may be preserved from a sender side to a receiver side.

The plurality of data packets may include an IPSec header that stores the flow identification in optional fields.

Policy based routing may be performed based on the flow identification information.

Quality of service may be provided based on flow identification information.

The flow identification may be part of a sequence number.

Embodiments also include a method of transmitting a plurality of data flows on a secure tunnel, including receiving a plurality of data packets from a plurality of data flows, distributing the plurality of data packets to a plurality of processing cores, wherein all the packets associated with a flow are distributed to a same processing core, encrypting a data portion of the plurality of data packets by the plurality of processing cores, adding a flow identification to an authenticated and unencrypted header of the plurality of data packets, and transmitting the plurality of data packets on the secure tunnel.

### BRIEF DESCRIPTION OF THE DRAWINGS

In order to better understand various exemplary embodiments, reference is made to the accompanying drawings, wherein:

FIG. 1 illustrates IPSec tunnels in a mobile backhaul network in accordance with embodiments described herein;

FIG. 2 illustrates IPSec processing of multiple flows in a single tunnel in accordance with embodiments described herein;

FIG. 3 illustrates IPSec processing with flow information available in ESP headers in accordance with embodiments described herein;

FIG. 4 illustrates an ESP packet format with an extension header in accordance with embodiments described herein;

FIG. 5 illustrates an ESP Packet format with 4-byte flow ID in accordance with embodiments described herein; and

FIG. 6 illustrates an ESP packet format with flow ID included in a sequence number in accordance with embodiments described herein.

### DETAILED DESCRIPTION

It should be understood that the figures are merely schematic and are not drawn to scale. It should also be understood that the same reference numerals are used throughout the figures to indicate the same or similar parts.

The descriptions and drawings illustrate the principles of various example embodiments. It will thus be appreciated that those skilled in the art will be able to devise various arrangements that, although not explicitly described or illustrated herein, embody the principles of the invention and are included within its scope. Furthermore, all examples recited herein are principally intended expressly to be for pedagogical purposes to aid the reader in understanding the principles of the invention and the concepts contributed by the inventor(s) to furthering the art, and are to be construed as being without limitation to such specifically recited examples and conditions. Additionally, the term, “or,” as used herein, refers to a non-exclusive or (i.e., and/or), unless otherwise indicated (e.g., “or else” or “or in the alternative”). Also, the various embodiments described herein are not necessarily mutually exclusive, as some embodiments can be combined with one or more other embodiments to form new embodiments. Descriptors such as “first,” “second,” “third,” etc., are not meant to limit the order of elements discussed, are used to distinguish one element from the next, and are generally interchangeable. Values such as maximum or minimum may be predetermined and set to different values based on the application. When steps of manufacture, process of using, or other method steps are described or claimed, the order of steps given is not constrained by the order presented, and may vary. Terms such as “below,” “above,” “right,” and “left,” may be used for relative orientation of a device or apparatus as illustrated in a figure. If an apparatus or component of a figure may be rotated and still function in a similar manner to what is described, the directional terms are not limited to the orientation illustrated in a particular figure. “Below” when rotated may become “right,” or “left” or “above.” The same holds true for the other directional indicators.

Embodiments described herein relate to the identification of different flows in a data stream, including identifying flows at an IP Security level in order to distribute encrypted data packets to multiple CPU cores for processing. By doing so, higher throughput may be achieved.

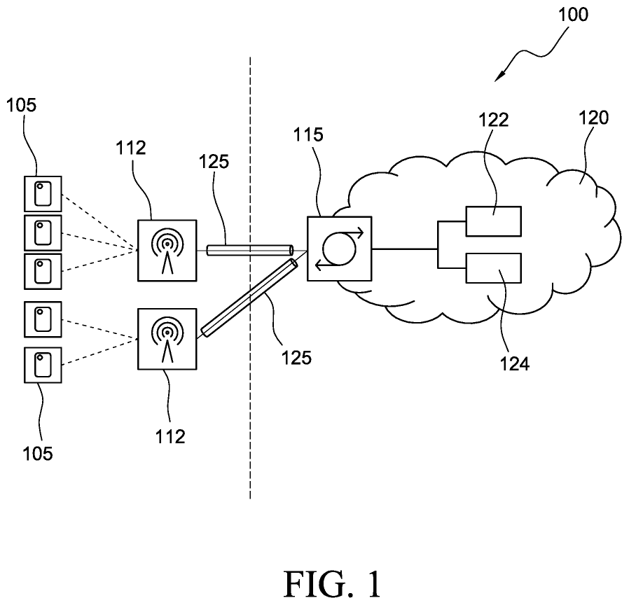

FIG. 1 illustrates internet protocol security protocol (IPSec) tunnels 125 in a mobile network 100 in accordance with embodiments described herein. Embodiments described herein may be used in a wide variety of IPSec environments such as IPSec VPN. An IP tunnel is a communications channel between two networks that can be used to transport a network protocol by encapsulation of its packets.

IPSec is a set of protocols that is configured to secure IP packet transmission across two end-points. When a secure tunnel is established between two endpoints, data packets may be processed on both sides and sent encrypted through the secure tunnel.

A network may include one or a plurality of user devices 105. The user devices 105 may send and receive data from one or a plurality of base transceiver stations (BTSs) 112. The BTSs 112 may communicate with a security gateway 115 having an IP address that further connects to a mobile core network 120. The mobile core network 120 may include a serving gateway (S-GW) 122 and a mobility management entity (MME) 124. Traffic between each BTS 112 and the security gateway 115 is secured with one or a plurality of IPSec tunnels 125. The IPSec tunnels 125 terminate on the BTS 112 in a radio access side towards one side of the dotted line and on a security gateway 115 on an edge of the mobile core network 120. Each BTS 112 uses a single IP address and establishes a single IPSec tunnel 125 to the core network 120.

An IPSec tunnel 125 may be defined as a plurality of security associations (SAs). A state-of-the-art model of IPSec usage involves establishment of the tunnel 125 using an encapsulating security payload (ESP) protocol to provide secrecy and integrity of an IPv4 or IPv6 payload sent across the SAs. ESP may be contrasted with an authentication header (AH) as the ESP provides that the entire payload is encrypted and integrity protected, which also may make processing ESP packets more expensive.

A constraint to be maintained during IPSec packet processing is that packets are transmitted (after processing) in receive order. In other words, re-ordering of packets is undesirable. Re-ordering of packets affects the throughput of higher level protocols that are encapsulated in an IPSec payload. Typically, IPSec processing involves different steps including fragmenting user equipment (UE) payload to a maximum threshold unit (MTU) size of the backhaul transport network. The payload is encrypted and sent towards the mobile core network 120. When receiving traffic from the mobile core network 120, data flows from different sources may be sent into different IPSec tunnels 125. The core payload is reassembled, the core payload is decrypted, and sent towards the user equipment (UE) having radio access protocols.

In previous methods, in the case of a single tunnel between two end-points, IPSec decryption and termination will occur on a single CPU core on the sender side and the receiver side, unless sophisticated schemes are used to parallelize packet processing with receive order preservation.

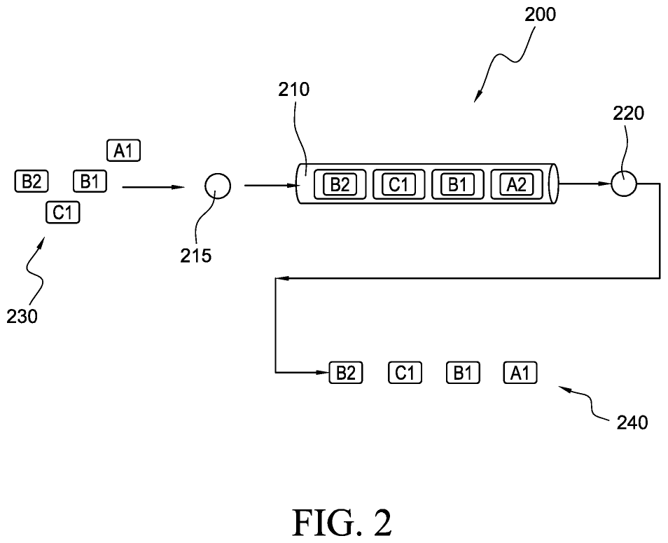

FIG. 2 illustrates IPSec processing 200 of multiple flows in a single tunnel 210 in accordance with embodiments described herein. FIG. 2 illustrates a representation of IPSec processing with a single sender core 215 and a single receiver core 220. A first group of packets 230 including Ai, Bi and Ci (where i=1, 2, . . . ) may be considered as three different flows. The letters A, B, C, etc. represent the flows and the suffixes I=1, 2, 3, etc. represent packets, in order, in the flows. Different flows may originate from same or different entities, such as UEs. A flow is a unique, end-end discriminant that is common among all packets of a stream. The flow may be constructed from the IP header fields, usually by hashing a source/destination IP address and/or source/destination port plus optionally, the payload protocol. In the case of encapsulating security payload (ESP) packets, the flow may be calculated from the payload. Each flow is independent, irrespective of whether it is bundled and transmitted in a single tunnel. When ESP packets are processed without flow information, the receive order of the ESP packets is preserved across all flows within the tunnel.

In previous solutions, when an IPSec packet 240 is received on a receive side from a single IP tunnel and it is decrypted, the IPSec packet 240 has to be decrypted onto a single core. The IPSec packet 240, which may be a group of several different flows, cannot be sent to many cores because the receiving side has to maintain the receive order. In addition, in previous systems, the single core would have to decrypt each data flow from different sent sources in order to decipher a correct destination point, which causes a bottleneck in the system. At the tunnel level, the receive side cannot distinguish between the flows that are internal to a tunnel that are encrypted, so if the system sees different flows of Ai, Bi, Ci, etc., the receive side cannot distinguish these flows. The receive side only sees an encrypted tunnel. It has to process the packets in order on a single core.

If a tunnel is distributed onto multiple cores, a problem of reordering arises. The receiver has a limited window in which to reorder packets before passing them on. The process can only be processed in that window, as packets are arriving for processing.

In the art, a user plane traffic rate in 5G mobile backhaul (BTS to S-GW) may be on the order of gigabits (>15 Gbps, expected to go to ˜50 Gbps) which is sent over a single IPSec tunnel. Adding additional tunnels and distributing traffic across these tunnels adds administrative overhead and complexities in network planning (assigning unique IP addresses for each tunnel, key management, managing more entries in the security policy database etc.) that is not favored by telco operators.

Embodiments described herein include structures and methods that may handle gigabit packet rates over a single IPSec tunnel of ESP packets in a scalable manner that is highly desired in evolving transport networks.

Embodiments described herein add flow information of inner packets into AH/ESP packets by extending the AH/ESP headers. This allows IPSec processing to be distributed based on the flow information onto multiple CPUs in parallel, using simple header inspection without decryption of a packet. Packet order preservation is satisfied because packets from a given flow will be sent to a same CPU for processing. The decryption of multiple flows can happen in parallel. This parallel processing yields faster decryption using multi-core processing power.

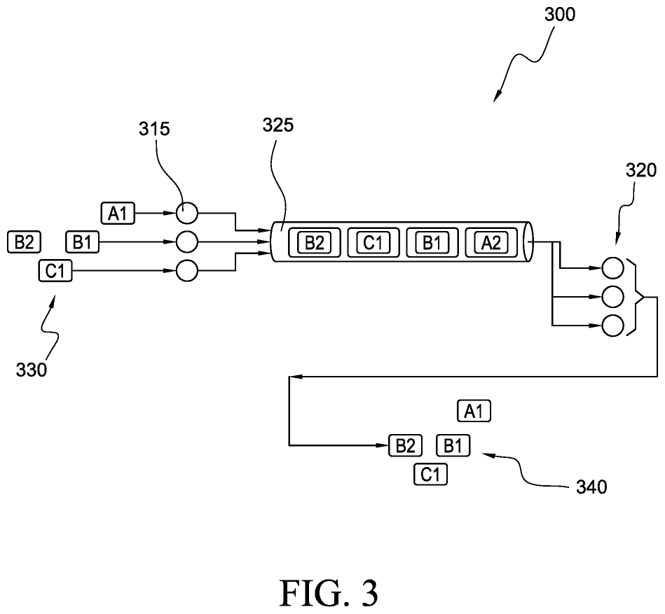

FIG. 3 illustrates IPSec processing 300 with flow information available in ESP headers in accordance with embodiment described herein. As illustrated in FIG. 3, flow information at a sender side may be recognizable by inspecting the ESP (outer) packet header which is then dispatched to individual processors 320 for processing.

At a transmit side, non-encrypted flow information will be added. By reading the non-encrypted flow information from the ESP headers, different flows may be distinguished at a receiver side without decrypting the packets because flow information is outside the encrypted packets. For example, flows A, B, and C are different flows that are separated out. A1 is a packet from flow A, B1 and B2 are packets from flow B, and C1 is a packet from flow C. Within the tunnel the packets are ordered and the flow can be scaled across multiple cores.

Embodiments described herein include scaling on the sender side and scaling on the receiver side. On the sender side, multiple cores may be used to input flow information onto a plurality of flows, entering a tunnel. On the receive side, based on the flow identifications (flow IDs), the different flow traffic is routed to different CPU cores 320 for separate, and overall faster, processing by preserving the order.

A flow of information may begin with packets 330 from different UEs that include different flows. Sender cores 315 may add ESP headers to each flow independently, with flow information. The sender cores 315 may begin IPSec processing of information per flow, which can be distributed by hashing or sender side scaling. Scaling may refer to the spreading out of the received data into multiple streams. Instead of using a single core, multiple cores are used which expands the possibility to process the flows across multiple cores, increasing the processing power and throughput of the system. In a tunnel 325, flow information may be made visible in ESP headers, and flows may be distributed to the dedicated receiver cores 320. The receiver cores 320 handle the IPSec processing per flow, distributing the flows by hashing or receiver side scaling. After individual processing in parallel cores 320, received packet order of packets 340 is preserved per flow.

Embodiments described herein may be implemented with no dedicated hardware or ordered queuing mechanism. Flow information is embedded in packet headers, obviating the need to calculate flows post decryption or use special classification schemes (e.g., RAM or content addressable memory (CAM) based). Packets may be distributed to CPU cores 320 (any commodity x86 processor and not a specialized crypto engine) by pinning flow IDs to cores and not in a round-robin scheme. Because flows can be determined from the flow IDs, a separate packet ordering mechanism (in hardware or software) is not needed.

Embodiments described herein may be used without hardware assist or engines. There are no separate queues for IPSec or non-IPSec flows. Embodiments include a negotiable extension that can operate in software solutions and in parallel with standard IPSec.

Several technological benefits inure from the structure and processes described herein, such as high throughput with software implementation on commodity hardware due to send and receive side linear scaling with lockless structures. Embodiments may be implemented in software without loss of performance scaling. Embodiments include inter-operability with classic IPSec in parallel, due to negotiability at the time of tunnel establishment. Possibilities include no change in network architecture and planning on the transport networks in front or backhaul network using IPSec single tunnel. Embodiments include enhanced anti-replay protection on a per flow basis. No new security implications may be implemented due to the addition of flow information in the ESP or AH header. For additional protection from any brute force approach to derive inner packet information, a negotiated salt (between the IPSec end points) at the time of tunnel establishment may be used in calculating the flow id along with source/destination IP and/or port and/or protocol information. Receive side scaling is included based on flow IDs that can be implemented in smart network interface card/controller (NIC)s. Embodiments include a single root-input output virtualization (SR-IOV) internal switch which may be configured to use flow based switching (rather than MAC address based switching) to virtual functions. There is also an ability to do policy based routing based of important traffic based on flow IDs in the ESP/AH headers.

Embodiments described herein include changes to IPSec standards, such as internet key exchange (IKF) negotiation for capability exchange of end points. Abilities include whether to use the extended format or not. There are extensions to ESP packet format, and per-flow sequence number and rekeying on sequence number roll-over.

Embodiments include IKF signaling for end-point capability. The existing IKF/ISAKMP mechanism may be enhanced to share the capability to support flow identifiers within IPSec headers, so that devices can transparently decide to use the proposed extensions, without losing backward compatibility and support a standard IPSec at a same time. On the sender side, addition of flow information is done based on receiver capability, while on the receiver side, a component responsible for flow based traffic distribution may fall back to standard IPSec processing if the sender side does not have the capability to encode flow information in the ESP header. Internet Key Exchange (IKF) based negotiation may be extended to make it possible for an entity like a security gateway to support both forms of IPSec simultaneously from two different BTSs, one with current IPSec and one with flow header, respectively.

Embodiments described herein include three different structures configured to place flow information in ESP packets without altering the integrity protection available on ESP fields that are discussed in detail below.

Embodiments described herein include scaling in multiple cores. Compared to previous handling schemes, according to embodiments described herein any flow distribution is possible before the packet decryption. The problem was that because the decryption had to happen in one core, that core would become a bottleneck, the capacity being limited by the capability of the IPSec.

Embodiments described herein include different proposals for adding information to the IPSec header. The flow information may be included in the portion of the header outside of the encrypted portion. The flows can may be distributed to different processors by hashing or receiver side scaling.

According to embodiments described herein, if there is a problem with one flow, because the flows are routed to different processor cores, a problem in one flow will not affect another flow. A backlog is not created. A flow ID may be added to the IPSec header when the header is sent.

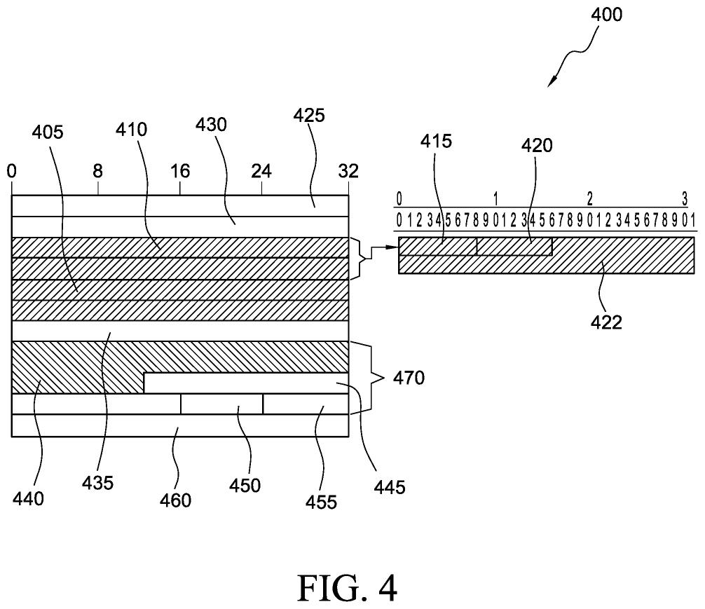

FIG. 4 illustrates an ESP packet format 400 with optional extension headers 405 and 410 in accordance with embodiments described herein. In FIG. 4, an ESP extension 405 and/or 410 header may be added that includes a flow identifier. The extension header is a 4-byte aligned, TLV format byte block in which the header data stores the flow identifier. The fields of the extension header include next header 415 (1 byte) which is configured to indicate the presence of a chained ESP extension header. Value 0 may be used in case no further extension headers are chained. A Length field 420 (1 byte) may be configured to indicate a length in octets of the flow identifier. A default value is assumed to be 2. The Flow ID is the identifier itself, with default length being two bytes (with values of 16 bits ranging from 0 to 65536), which is sufficient to cover most use cases. Header specific data 422 may also be included.

This will identify a flow such that the flow information can be used by a central node at the receive side, the receiver that is processing the IPSec packets, which can look at the flow information in the IPSec data without decrypting the actual packet. Without having to decrypt an IPSec packet, the packet can be further distributed into different CPU cores. The actual decryption can then efficiently happen in the different CPU cores. Additional packet fields may include a security parameter index (SPI) 425, a sequence number 430, an optional initialization vector 435, the actual data 440, a padding layer 445, padding length 450, next header 455 information, and authentication data 460. The entire packet 400 may be authenticated while a portion 470 including the data 440, padding 445, padding length 450, and next header 455 information may be encrypted.

In this case, the ESP header may be augmented with an extension header containing a flow identifier at the time of IKF negotiation to create the IPSec end-points and the existing fields that are not affected in their structure or interpretation. Extension headers may also be chained. However, adding many chained extension headers can end up in large IPSec packets which may be fragmented, when maximum transmission unit (MTU) size is limited to 1500.

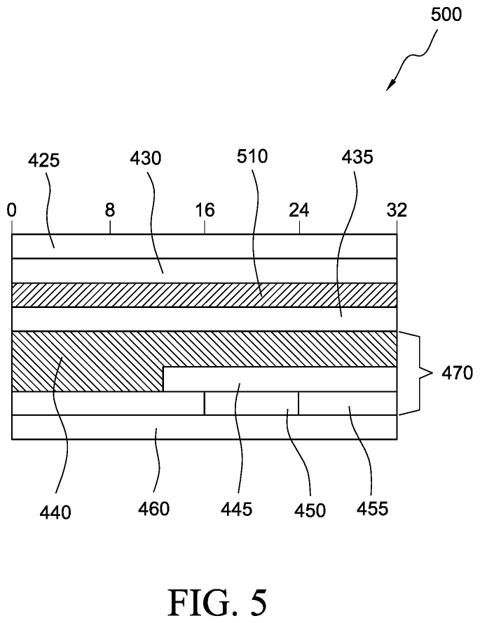

FIG. 5 illustrates an ESP Packet format 500 with 4-byte flow ID 510 in accordance with embodiments described herein. The IPSec packet 500 includes payload information as described in FIG. 4 including data 440. A flow ID 510 is inserted as part of the external header. The flow ID 510 is not encrypted. Once the flow info is added, it cannot be tampered with by an intermediate node. If it is tampered with, then the packet can be destroyed.

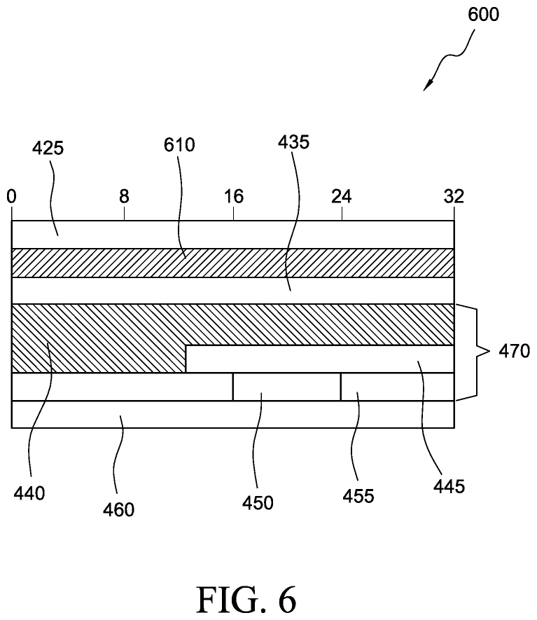

FIG. 6 illustrates an ESP packet format 600 with flow ID included in a sequence number 610 in accordance with embodiments described herein. In the third variant, the flow identifier is accommodated into the sequence number 610, by negotiating a specific set of bits for the flow ID and the remainder for the sequence number 610 at the time of Internet Key Exchange (IKF) negotiation. For example, with a 32-bit sequence number 610, 10 bits may be used for the flow ID (implies that 1024 flows can be supported) and the remaining 22 bits for the sequence number 610. The IPSec packet 600 includes payload information as described in FIG. 4 including data 440

Another embodiment includes incorporating a flow ID into a 64-bit sequence number field. In a 64-bit option, ten bits may be used for the flow information. Therefore fifty-four bits may be available for the sequence number processing. Thus the flow ID may be used as part of the sequence number without decryption.

While processing multiple flows in parallel, embodiments described herein have sequence numbers per inner flow rather than per tunnel. Having a global sequence number requires a cache-coherent atomic variable that is visible across all CPUs that process the flows—which makes it a locking bottleneck, affecting scalability. This also means that sequence number rollover may happen at different times in different flows, and if the flow rates are evenly balanced, there can be a flurry of re-keying as each sequence number rolls over. To prevent this, embodiments described herein re-key when the flow with the highest sequence number rolls over and simultaneously resets sequence numbers for all flows that are part of the tunnel. Hence, the time or threshold based IPSec re-keying may be continued. If proposed extended ESP packet formats are compared, some variants allow a longer time for sequence number rollover because each flow gets a 64-bit space. Sequence numbers roll over relatively faster in the third variant compared to the other two.

Ethernet link speeds have moved to gigabit speeds in the last few years and even 40/100G links are expected to be common in the near future. Embodiments described herein achieve linear receiver side and sender scaling of IPSec packet processing across multiple CPU cores, without relying on specialized crypto hardware. This property makes it an excellent candidate for utilizing commodity hardware (e.g. x86 processors with high speed Network Interface Cards/Controllers (NICs)) for IPSec crypto processing, especially given the fact that processors such as Intel provide vectorised instructions such as Advanced Encryption Standard-New Instructions (AES-NI).

A model of send side scaling may be applied to dispatch different flows to different NICs wherein the NICs effectively act as a link-aggregation scheme for high link-level throughput without the complexity of a link aggregation group (LAG) driver. Embodiments described herein are an extension to the current IPSec standards. Accelerated software performance can be achieved with fast path solutions such as data plane development kit (DPDK) or netmap. Having a software model allows flexible deployment in bare-metal and cloud environments without any changes whatsoever.

The described flow based distribution mechanism is usable in the authentication header (AH) as well, because the flow id can either be added as a part of AH or may be dynamically generated from the payload, without being encoded in the AH. In AH, the payload is not encrypted, but only integrity protected.

For gigabit rate processing, the anti-replay window may be larger than 64 bits, if sequence numbers are global across flows within the IPSec tunnel. By separating sequence numbers on a per-flow basis, the window can be kept smaller (e.g. 64 per flow), thereby improving anti-replay mechanism.

The proposal has no new security implications because the ESP/Authentication Header (AH) security model is not disturbed (e.g., integrity protection and encryption stays as-is) and no attacker can gain any important information about the inner packet or the nature of payload by studying the flow information in ESP header. The random salt value negotiated at the time of IPSec session establishment may be used in the flow calculation. When used, an attacker will not be able to derive any information about an inner packet from the flow id.

Embodiments described herein provide high throughput IPSec processing for 5G backhaul and fronthaul networks using IPSec tunnels containing multiple flows encrypted as ESP packets.

Embodiments may also be implemented in smart Network Interface Cards/Controllers (NICs) to provide Receive Side Scaling (RSS) without having to implement complete IPSec accelerators or crypto engines. For example, the RSS mechanism in a smart NIC may be programmable to switch flows directly to CPUs. Similarly, a Single Root-Input Output Virtualization (SR-IOV) capable NIC could switch based on flows rather than MAC addresses so that the flows are directly switched to respective virtual devices.

With the proposed extensions, it is possible to do policy based routing for certain flows, e.g., imagine a set of UEs accessing a certain service such as a banking system. The flow ID falls within a certain set depending on the destination address and port. Being a secure service provider, it is possible to have this set applied to a policy based routing engine such that packets with this flow(s) are routed through a preferential route, while ordinary flows are routed through the normal route(s). Policy based routing examples include equal access, differing next hops, and others.

Any combination of specific software running on a processor to implement the embodiments of the invention, constitute a specific dedicated machine.

As used herein, the term “non-transitory machine-readable storage medium” will be understood to exclude a transitory propagation signal but to include all forms of volatile and non-volatile memory.

It should be appreciated by those skilled in the art that any block diagrams herein represent conceptual views of illustrative circuitry embodying the principles of the invention.

Although the various examples of one embodiment have been described in detail with reference to certain exemplary aspects thereof, it should be understood that embodiments described herein are capable of other embodiments and its details are capable of modifications in various obvious respects. As is apparent to those skilled in the art, variations and modifications can be affected while remaining within the spirit and scope of the embodiments. Accordingly, the foregoing disclosure, description, and figures are for illustrative purposes only and do not in any way limit the invention, which is defined only by the claims.

What is claimed is:

1. A method of identifying a flow in a received data stream from a secure tunnel, comprising:
receiving a plurality of data packets including a flow identification and an encrypted data portion;
separating a flow identification from the encrypted data portion;
distributing the plurality of data packets to a plurality of processing cores, wherein all the packets associated with a flow identification are distributed to a same processing core.

2. The method of claim 1, comprising:
decrypting data packets in multiple flows based on the flow identification information by the plurality of processing cores, wherein the decryption of the multiple flows occurs in parallel.

3. The method of claim 1, wherein distributing the plurality of data packets is performed by header inspection without decryption of the packet.

4. The method of claim 1, wherein distributing the plurality of data packets is performed using a hashing function.

5. The method of claim 1, wherein distributing the plurality of data packets is performed using receiver side scaling.

6. The method of claim 1, wherein a packet order is preserved from a sender side to a receiver side.

7. The method of claim 1, wherein the plurality of data packets include an IPSec header that stores the flow identification in optional fields.

8. The method of claim 1, wherein policy based routing is performed based on the flow identification information.

9. The method of claim 1, wherein quality of service is provided based on flow identification information.

10. The method of claim 1, wherein the flow identification is part of a sequence number.

11. A method of transmitting a plurality of data flows on a secure tunnel, comprising:
receiving a plurality of data packets from a plurality of data flows;
distributing the plurality of data packets to a plurality of processing cores, wherein all the packets associated with a flow are distributed to a same processing core;
encrypting a data portion of the plurality of data packets by the plurality of processing cores;
adding a flow identification to an authenticated and unencrypted header of the plurality of data packets; and
transmitting the plurality of data packets on the secure tunnel.

12. The method of claim 11, wherein distributing the plurality of data packets is performed using a hashing function.

13. The method of claim 11, wherein distributing the plurality of data packets is performed using receiver side scaling.

14. The method of claim 11, wherein a packet order is preserved on a sender side and on a receiver side.

15. The method of claim 11, wherein the unencrypted header is an IPSec header that stores the flow identification in optional fields.

16. The method of claim 11, wherein the flow identification is part of a sequence number.

17. The method of claim 11, wherein policy based routing is performed based on the flow identification information.

18. The method of claim 11, wherein quality of service is provided based on flow identification information.
